(19) United States
(12) Patent Application Publication
(10) Pub. No.: US 2011/0109120 A1
(43) Pub. Date: May 12, 2011

(54) Equipping a vehicle roof with a collapsible platform convertible to general living space

(76) Inventor: Tim Bonerb, Kansas City, MO (US)

(21) Appl. No.: 12/864,320

(22) PCT Filed: Aug. 14, 2008
(86) PCT No.: PCT/US08/73180

§ 371 Date: Jan. 26, 2011

Related U.S. Application Data
(60) Provisional application No. 61/063,468, filed on Feb. 1, 2008.
(60) Provisional application No. 61/126,851, filed on May 7, 2008.
(60) Provisional application No. 61/130,024, filed on May 27, 2008.

(51) Int. Cl. B60P 3/345

(52) U.S. Cl. 296/164

(57) ABSTRACT

Improvements in the device and method of equipping the roof area of a vehicle with a lightweight and collapsible platform that can be used with or without the vehicle attached for general living purposes. It is a lightweight, removable and collapsible platform that can be easily and quickly converted to a the invention is made of lightweight materials and designed with a low profile, aerodynamic design so that the roof of a typical car or truck can support the load while on the road, as well as operate safely and efficiently. The invention is equipped with support legs (3, 18) that extend to the ground to protect the vehicle's roof from damage resulting from overloading as well as allowing the invention to be used as a stand-alone platform without the vehicle parked underneath.

### BACKGROUND OF THE INVENTION

1. Field of Invention

The present invention relates to a method and apparatus for equipping vehicles such as cars, SUV's, vans, trailers, ATV's and trucks with a lightweight and collapsible platform that can be used for general living purposes whether attached to a vehicle or used as a stand alone platform.

2. Description of Related Art

The desirability of having a roof mounted enclosure on a vehicle that can be collapsed for transport and then opened for one to sleep in once the vehicle is parked is well known. Much of the prior art relies on the roof of the vehicle to support the enclosure plus a person's weight and thereby limit's the number of people to one or possibly two that can safely use the enclosure without causing damage to the vehicle. Some other patents rely on fold out decks for extra space that may be supported by a post. Almost all previous patents do not provide for general living use such as standing, walking around, sitting in a chair or sleeping on a cot (off of the floor) as well as accommodating up to five to 10 people at a time. Most of the previous patents are for very heavy and complicated enclosures that rely on the additional support of a vehicle's bumper and wheels and as a result could not fit on most current vehicles with modern bumpers that are typically made of plastic and are used to operate driver air bags.

For example, Phillips U.S. Pat. No. 5,544,671 discloses a collapsible shelter that can be opened on one end that can provide an area for sleeping only for a maximum of two people to lay down in with the weight of the people and the collapsible shelter being supported by the roof of the vehicle.

Green U.S. Pat. No. 3,11,955 discloses a box-like structure utilizing four tubular uprights which are fixed to the front and rear bumpers of the vehicle. The box-like living structure is secured to this frame and is capable of expansion so as to form living quarters.

Serino U.S. Pat. No. 3,733,102 discloses a large and heavy box like structure that can be expanded upward that uses one post on each side of the vehicle to stabilize the structure once the vehicle is parked and expanded.

Barr U.S. Pat. No. 4,176,873 discloses a collapsible enclosure, installed on the camper top of a pick up truck that has a large deck that is unfolded over the hood area of the truck for extra sleeping space with a low headroom area. The two support posts that support the deck rest on the hood of the truck.

Japanese Pat. No 09-183342 discloses a roof top mounted enclosure tent that can be unfolded towards the side of the vehicle to create extra sleeping space that is supported with poles, without cross braces, to the ground.

A need remains within the industry for an improved shelter/camper assembly which that can be used with the current designs of automobiles, is lightweight and easily transportable, relies on the strength of the roof of the vehicle for transport only, has sufficient headroom for general living use and that can be used as a stand alone platform if desired.

### SUMMARY OF THE INVENTION

It is an object of the invention to provide a lightweight, portable, aerodynamic and collapsible platform that can be converted to sheltered living space that does not rely on the strength and structure of the vehicle roof to support the load of cargo and people using the platform.

It is an object of the invention for the expandable deck frame to be stowed inside the base frame and extend to slide in and out from the base frame as opposed to folding and getting caught in the wind.

It is another object of the invention is to transfer the load of its contents to the ground via a minimum of four supports.

It is another object of the invention to provide safe access to and from the collapsible platform area with the use of proper guard and hand rails.

It is another object of the invention to provide a foldable roof assembly that may be equipped with a flexible enclosure for closed living space.

It is still another object of the invention to use the collapsible platform whether attached to the vehicle or as a stand alone structure.

It is till another object of the invention to use a universal mounting system that does not require interfacing with the vehicle's roof rack.

It is another object of the invention to spread the load of the collapsible platform across a large area of the roof a vehicle.

It is another object of the invention to secure all support posts with cross bracing and or gusseted joints.

It is another object of the invention to secure collapsible platform to vehicle by attaching heavy duty webbing straps and or cables through doorways or windows of vehicle.

The invention is a lightweight, removable and collapsible platform that can be easily and quickly converted to a the invention is made of lightweight materials and designed with a low profile, aerodynamic design so that the roof of a typical car or truck can support the load while on the road, as well as operate safely and efficiently. The invention is equipped with support legs that extend to the ground to protect the vehicle's roof from damage resulting from overloading as well as allowing the invention to be used as a stand-alone platform without the vehicle parked underneath. The invention may also be equipped with a variety of options including a ladder and hand rail assembly, a roof frame and flexible enclosure, an extended deck area, side floor extension panels and a guard rail assembly. These and other features, aspects, and advantages of the present invention will become better understood with regard to the following description, claims, and accompanying drawings.

### BRIEF DESCRIPTION OF DRAWINGS

FIG. 1 is a side view of collapsible platform attached to a vehicle for transport.

FIG. 2 is a side view of vehicle showing the deck frame extended from the base frame of the collapsible platform as well as the support posts lowered which are used to support deck frame and base frame of collapsible platform.

FIG. 3 is a side view vehicle with deck frame extended, support posts set up and ladder attached to collapsible platform.

FIG. 4 is a side view of collapsible platform used as a stand alone platform with vehicle removed.

FIG. 5 is a side view of collapsible platform attached to vehicle with deck frame extended, support posts extended to ground and braced and roof raised and secured for use.

FIG. 6 is an end view of collapsible platform on vehicle with support post assemblies extended to ground, ladder secured to roof post frame with roof assembly raised and side floor extensions during set up.

FIG. 7 is a top view of base frame with support post assemblies installed.

FIG. 8 is a top view of base fame with deck frame installed.

FIG. 9 is a partial end view of base frame deck frame roller assembly.

FIG. 10 is an end view of base frame with side floor extended and support post assembly set up.

FIG. 11 is a top view of deck module and roller assembly.

FIG. 12 is a side view of pick up truck with collapsible platform with deck frame enclosure and guard rail set up.

FIG. 13 is a side view of base frame with deck frame installed.

FIG. 14 is a side view of base frame with deck frame extended with guard rail and support post assemblies set up.

FIG. 15 is a detailed side view of safety strap connected between door frame inside vehicle and collapsible platform.

FIG. 16 is a side view of collapsible platform set up for use and installed on a trailer.

FIG. 17 is a side view of a wall of the flexible enclosure and roof assembly.

FIG. 18 is a side view of collapsible platform being lowered onto vehicle for installation.

FIG. 19 is a side view of collapsible platform with top and bottom flexible enclosures installed.

### DETAILED DESCRIPTION OF DRAWINGS

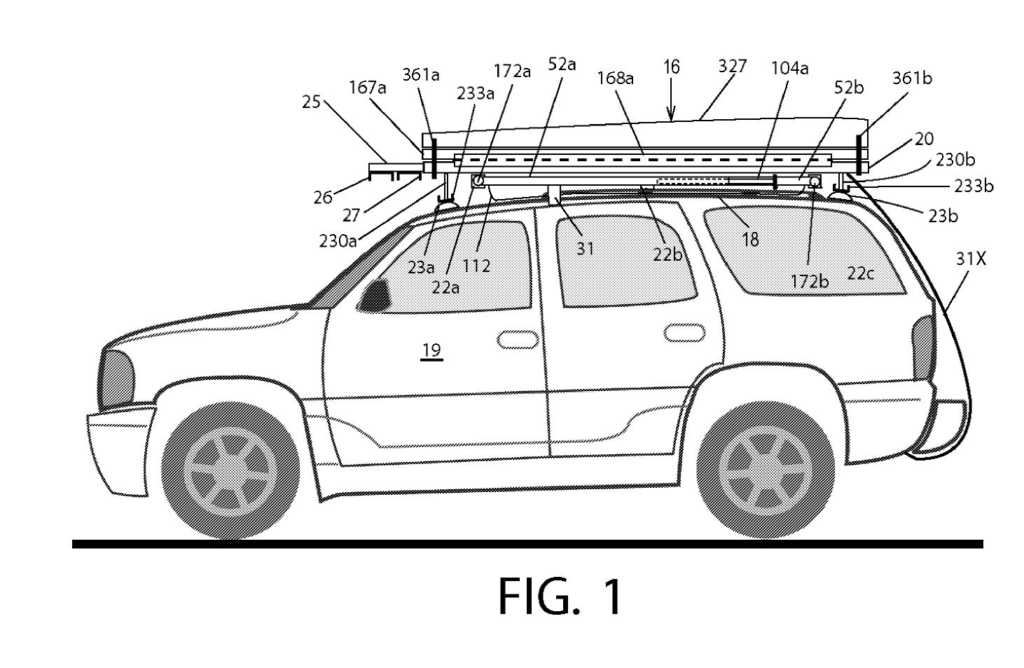

FIG. 1 is a side view of vehicle 19 with collapsible platform 16C secured to roof 18. Base frame 20 is equipped with suction cups 23a and 23b and 23c and 23d (not shown) on the opposite side that rest on vehicle roof 18 with support membrane 112 located between vehicle roof 18 and underside of base frame 20. Support membrane 112 may be filled with low pressure air or with a foam resin material to spread the load of collapsible platform 16C over a large area of vehicle roof 18 whereby suction cups 23a, 23b, 23c and 23d only apply a relatively small, concentrated load on vehicle roof 18. Support membrane 112 may be inflated or filled with foam accordingly and used in conjunction with extensions bolts 230a and 230b (230c and 230d not shown) to position base frame 20 on or above roof rack 121 as desired by the user. To secure collapsible platform 16 to vehicle 19, safety straps 31a and 31b (not shown), that are connected to base frame 20 via safety flanges 29a and 29b (not shown) respectively, safety strap 31a 31b extend inside vehicle 19, from one side to the other, through doorways or windows on opposing sides of vehicle 19 and are connected together and tightened. As shown, in this configuration, base frame 20 is equipped with deck 25 and corresponding deck end support 26 and deck support 27, roof assembly 327, extension floor hinge 168a between base frame 20 and extension floor 167a. Roof assembly 327 is equipped with roof straps 361a and 361b that are secured to base frame 20 to hold these components down and tight against base frame 20 during the transport mode. Also, as shown, support posts 52a and 52b (52c and 52d not shown) are shown in their horizontal position and secured to base frame 20 during the transport mode. To provide further stability to collapsible platform 16C during the transport mode, safety strap 31x is fixed to base frame 20 and extended under the bumper of vehicle 19 and secured to the frame of vehicle 19. This is especially useful and provides a high level of safety, especially in case of emergency stops or even a head-on collision to prevent collapsible platform 16C from sliding forward on vehicle roof 18.

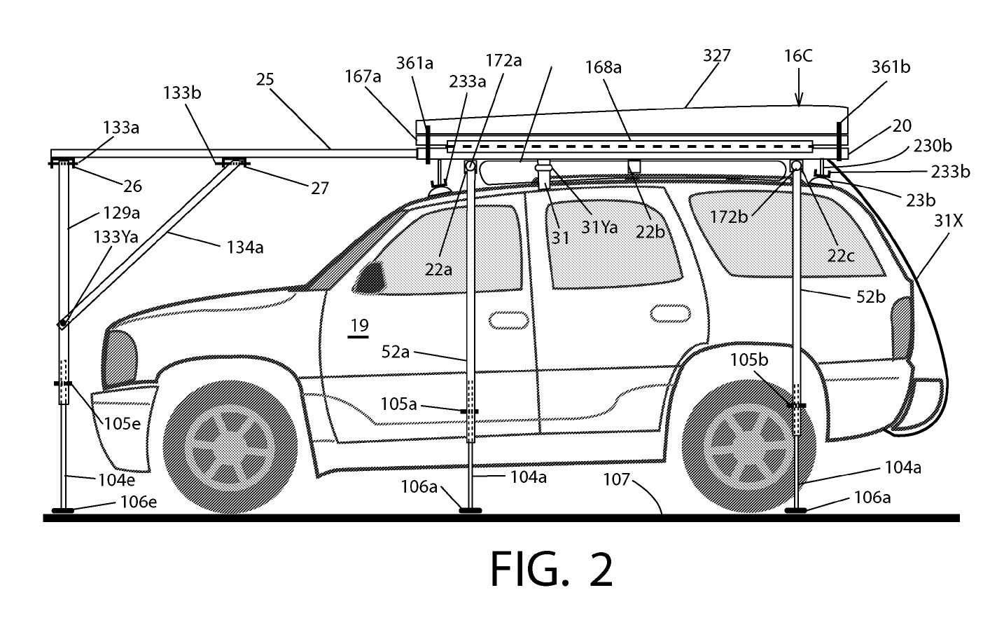

FIG. 2 is a side view of vehicle 19 showing deck frame 25 extended from base frame 20 and support posts 52a and 52b pulled out from their stowage location (support posts 52c and 52d not shown) on base frame 20 and extended to ground 107. While vehicle roof 18 can support the weight of collapsible platform 16C during transport, support posts 52a, 52b (52c and 52d not shown) transfer the load of collapsible platform 16c, cargo and persons to ground 107 for use. Depending on the model offered, collapsible platform 16c may support a load from 1,000 to 2,000 pounds. Also shown is deck frame 25 pulled out from its stowed position inside base fame 20 and extended forward over the hood of vehicle 19 with deck support post 129a extended to ground 107. Deck frame 25 can also be designed to extend to the side or back of vehicle 19. To support deck frame, deck end support 26 and deck support 27 run cross ways under deck frame 25. While deck end support 26 is fastened to deck frame 25, deck support 27 is hung from deck frame 25 and is allowed to move back and forth on deck frame 25 via rollers or slides (not shown) and locked in place as required. As shown, deck brace 134a (134b not shown) is secured to deck support 27 via deck pin 133b and is fastened to deck support post 129a via brace pin 133Ya. To provide adjustment for different surfaces of ground 107, support posts 52a, 52b and 52c and 52d (not shown) are equipped with extension legs 104a, 104b and 104c and 104d (not shown) that may be adjusted up or down with leg locks 105a, 105b and 105c and 105d (not shown) respectively. Feet pads 106a, 106b and 106c and 106d (not shown) may be secured to extension legs 104a, 104b and 104c and 104d (not shown) to provide greater stability. Likewise, deck support posts 129a and 129b (not shown) are equipped with extension legs 104e and 104f (not shown), leg locks 105e and 105f (not shown) and foot pads 106e and 106f respectively.

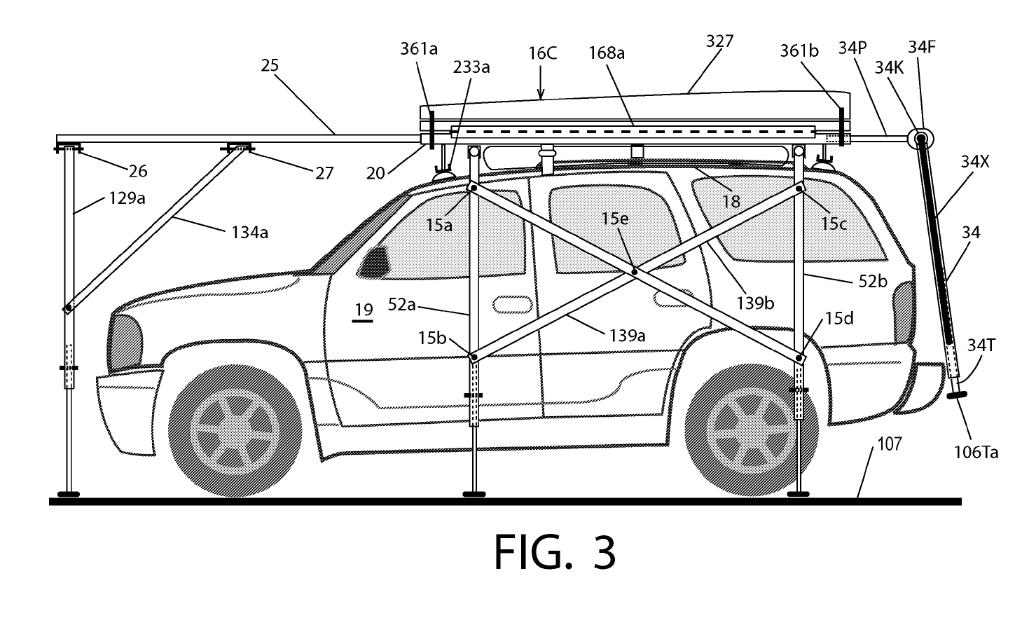

FIG. 3 is a side view of vehicle 19 parked with collapsible platform 16C on vehicle roof 18 prior to set up. Ladder 34 may be attached to base frame 20 for transport or stowed inside vehicle 19. Ladder 34 is equipped with ladder platform 34p, ladder handrail 34X, ladder extension 34T and foot pads 106Ta and 106Tb (not shown). Also shown, are support posts 52a and 52b stabilized with the attachment of frame beams 139a and 139b.

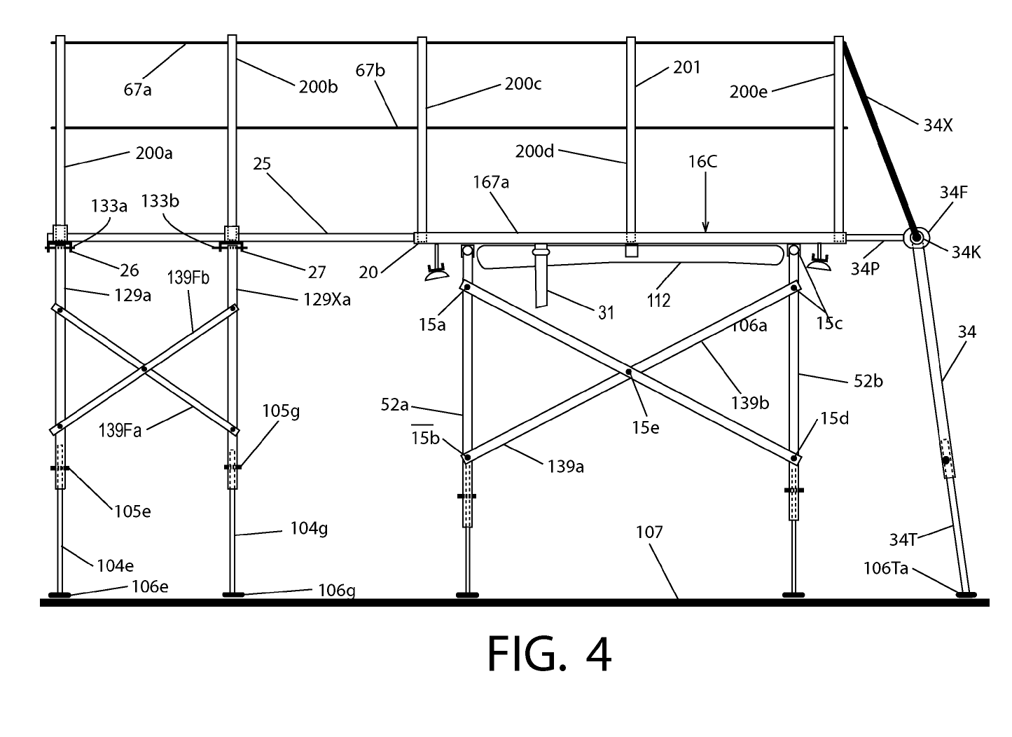

FIG. 4 is a side view of collapsible platform 16C standing on ground 107 with vehicle 19 removed. To provide greater stability and support to deck frame 25 for handling heavy loads, an extra set of deck support posts 129Xa and 129Xb (not shown) are fixed under and to deck support 27. Frames beams 139Fa, 139Fb and 139Fc and 139Fd (not shown) are fastened between deck support posts 129a and 129Xa and 129b and 129Xb (not shown). Also shown is ladder 34 with ladder extension 34T locked and lowered to ground 107. Ladder 34 is connected to ladder platform 34P via ladder flange 34F whereby ladder 34 and ladder handrail 34X rotate on ladder axle 34. Ladder hand rail 34X may be locked in the up position as shown or in the down position for the transport mode. Once safety strap 31 is unfastened and suction cups are released, support membrane 112, shown as attached to base frame 20, may be used to raise and lower collapsible platform 16C by further inflation or deflation of low pressure air with blower (not shown) for installation and/or removal from vehicle roof 18 of vehicle 19. As the deflation or inflation of support membrane 112 occurs, support posts 52a, 52b and 52c and 52d may be readjusted and locked to allow vehicle 19 to move away from under collapsible platform 16C. Blower may be any device that can be operated via a cord and electrical outlet, by battery and/or from a cigarette lighter port of vehicle 19.

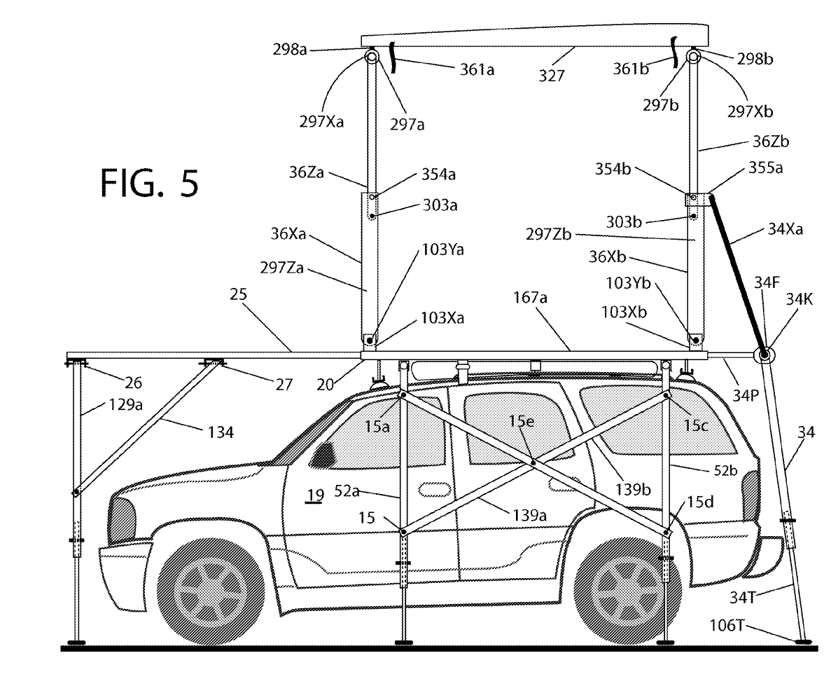

FIG. 5 is a side view of vehicle 19 with collapsible platform 16C installed. In this configuration, roof assembly 327 is supported on base frame 20 via roof post assemblies 297Za, 297Zb, 279ZC (not shown) and 297Zb (not shown). The bottom end of bottom roof post 36Xa is secured to base frame 20 via post flange 103Xa and may rotate from a horizontal to vertical position via post flange axle 103Ya. Top roof post 36Za is connected to bottom roof post 36Xa via roof post axle 303a and can be locked together with bottom roof post 36X with joint lock pin 354a to form a vertical column to support roof assembly 327. Roof beam connector 298a is secured between roof assembly 327 and roof beam collar 297a so that roof beam collar 297a may rotate on roof beam hub 297Xa fixed to top roof post 36Za. To raise roof assembly 327 from base frame 20, bottom roof post 36Xa is rotated in a counterclockwise direction on post flange axle 103Ya. As bottom roof post 36Xa raises off base frame 20, top roof post rotates on roof post axle 303a in a clockwise direction until both bottom roof post 36Xa and 36Za are in a vertical positions so that joint lock pin 354a may be inserted as shown. Likewise, roof post assemblies 297Zb, 297Zc (not shown) and 297Zd (not shown) function in a similar manner to roof post assembly 297Za. As shown, roof post assembly 297Zb is attached between base frame 20 and roof assembly 327 with bottom roof post 36Xb attached secured to base frame 20 via post flange 103Xb and may rotate from a horizontal to vertical position via post flange axle 103Yb. Top roof post 36Zb is connected to bottom roof post 36Xb via roof post axle 303b and can be locked together with bottom roof post 36X with joint lock pin 354a to form a vertical column to support roof assembly 327. Roof beam connector 298b is secured between roof assembly 327 and roof beam collar 297b so that roof beam collar 297a may rotate on roof beam hub 297Xb fixed to top roof post 36Zb. To raise roof assembly 327 from base frame 20, bottom roof post 36Xa is rotated in a clockwise direction on post flange axle 103Yb. As bottom roof post 36Xb raises off base frame 20, top roof post rotates on roof post axle 303a in a counterclockwise direction until both bottom roof post 36Xa and 36Za are in a vertical positions so that joint lock pin 354a may be inserted as shown. Once post assemblies 297z and 297D (not shown) are locked in place as a single column with joint lock pins 354b and 354d (not shown), they may be secured to ladder hand rails 34Xa and 34Xb (not shown) via post locks 355a and 355b (not shown) to provide support and stability. Under normal operating conditions, the user would set up roof post assemblies 297Zb and 297Zd (not shown) first and secure them the ladder hand rails 34Xa and 34Xb (not shown) via post locks 355a and 355b (not shown) and then proceed to set up roof post assemblies 297Za and 297Zc (not shown) to their vertical column configurations. While Ladder platform 34P is no always required, ladder 34 could be attached directly to base frame 20, it does provide a safe and stable area for the user to stand on while raising and lowering roof assembly 327.

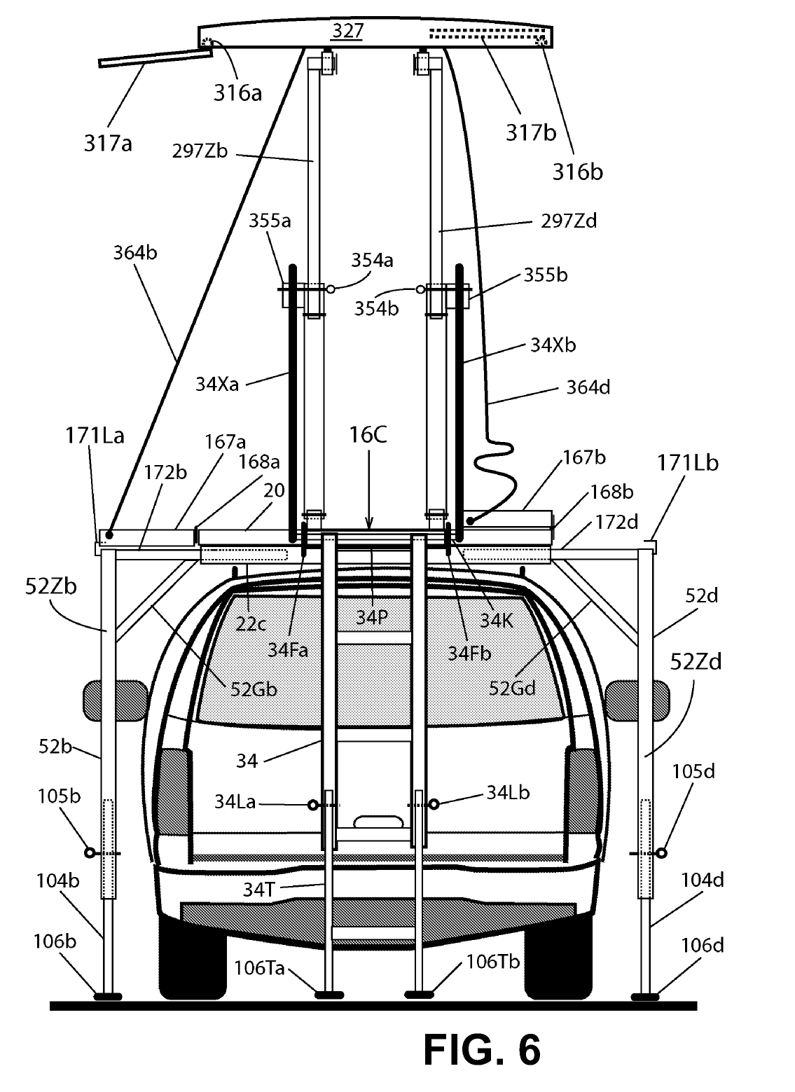

FIG. 6 is an end view of vehicle 19 with collapsible platform 16C installed during set up. In preparing collapsible platform 16C for use, support post assemblies 52zb, 52Zd, 62Za (not shown) and 52Zc (not shown) are pulled outward from base frame 20 and rotated within roof struts 22c and 22a (not shown) and lowered to ground 107. Support post 52a, support post gusset 52Gb and support post beam 172b are typically welded together to form support post assembly 52Zb. To provide support post assemblies 52Zb with adjustability for different ground surfaces, extension leg 104c with foot pad 106b may be extended for different heights with leg lock 105b. Also shown is support post 52d, support post gusset 52Gd and support post beam 172d welded together to form support post assembly 52Zd. Similarly, support post assemblies 52Za (not shown) and 52Zc are fabricated in the same manner. As shown, ladder extension 34T is lowered to ground 107 from ladder 34 and locked in place with ladder pins 34La and 34Lb. Ladder 34 may pivots on ladder axle 34K, in and out from vehicle, for the user to gain the ideal placement of ladder 34 with respect to vehicle 19. Once ladder 34 is locked and in the preferred position, ladder hand rails 34Xa and 34Xb are rotated upward via ladder axle 34K and locked in the up position. Once ladder handrails 34Xa and 34Xb are locked in the up position, the user has a safe and stable area to perform the other set up procedures from platform 34P and base frame 20. Ladder flanges 34Fa and 34Fb are secured to ladder platform 34P to hold ladder axle 34K in place. Both ladder 34 and ladder hand rails 34Xa and 34Xb may rotate on ladder axle 34K.and pride support As shown, extension floor 167a is rotated outward via extension floor hinge 168a, that is also secured to base frame 20, so that it comes to rest on support post beam 172a of support post assembly 52Zb. To provide linear support to roof assembly 327 so that it doesn't sway back and forth, especially in windy conditions, guy wire 364b is secured between roof assembly 327 and extension floor 167a. So that extension floor remains secured to support post assembly 52Zb, latch 171La is fastened between extension floor 167a and support post beam 172b. Also as shown is extension floor 167b that remains in its stowed position during transport and connected to base frame 20 via extension floor hinge 168b. To provide further liner support to roof assembly 327, guy wire 364d is connected between roof assembly 327 and extension floor 167b and will not become taught and useful until extension floor 167b is folded outward and latch 171Lb is fastened between extension floor 167a and support post beam 172d. If desired, joint lock pins 354a and 354b may be used in conjunction with post locks 355a and 355b to hold roof post assemblies 297Zb and 297Zd in a vertical and stable position to ladder hand rails 34Xa and 34Xb. Roof extension 317a is shown as extended outward from roof assembly 327 via roof axle 316a to provide a greater sheltered area whereby roof extension 317b is stowed under roof assembly 327 and rotated inward via roof axle 316b during transport.

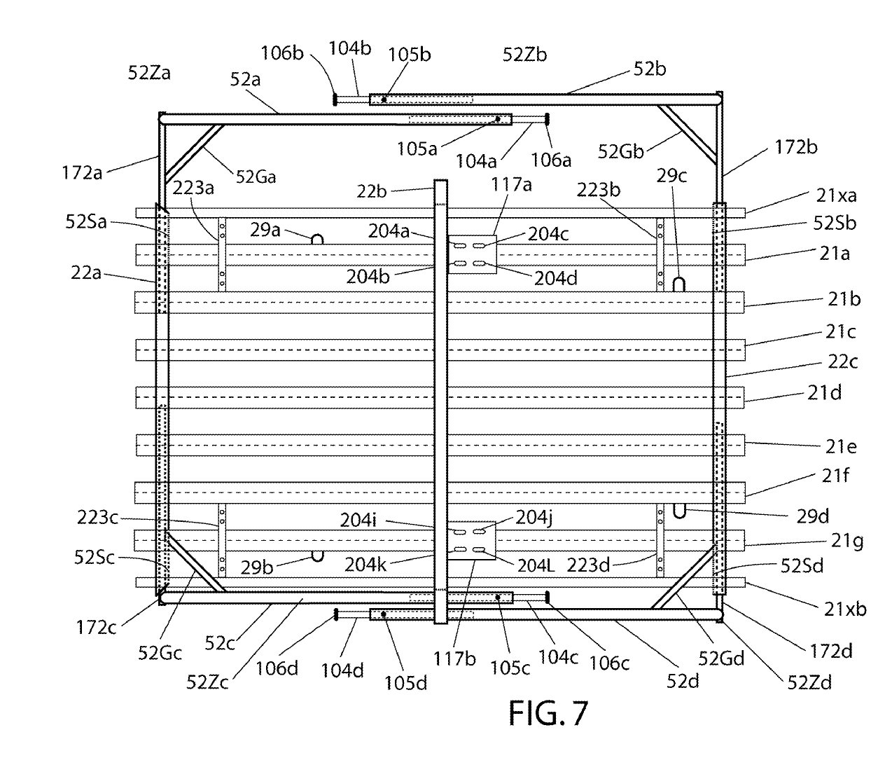

FIG. 7 is a bottom view of base frame 20 primarily comprised of roof struts 22a, 22b, 22c, 22d and 22e and floor beams 21a, 21b, 21c, 21d, 21e, 21f and 21g with side channels 21ax and 21xb. These components are typically welded together, however, rivets and other fastening means may be used. As part of the base frame 20 are the suction cup brackets 223a, 223b, 223c and 223d and roof frame flanges 117a and 117b. Again, these components are generally welded to one or more of roof struts 22a, 22b, 22c, 22d and 22e. Also shown are safety flanges 29a, 29b, 29c and 29d that are part of the base frame 20 of collapsible platform 16C. To limit the load of base frame 20 (and other components of collapsible platform 16C, such as deck frame 25, ladder 34, guard rail assembly 201, flexible enclosure 32 and persons—all not shown), support post assemblies 274a, 274b, 274c and 274d transfer the load on floor 28 (not shown) of base frame 20 to the ground 107 (not shown). Support post assemblies 52Za, 52Zb, 52Zc and 52Zd are typically made by welding support post beams 172a, 172b, 172c, 172d, support gussets 52Ga, 52Gb, 52Gc and 52Gd and support posts 52a, 52b, 52c and 52d together. As shown, gusset slots 52Sa, 52Sb, 52Sc and 52Sd are placed in rood struts 22a, 22b, 22c and 22d respectively to allow supports gussets 52Ga, 52Gb, 52Gc and 52Gd to rest in when they are in the transport mode. As shown, support post assemblies 52Zc and 52Zb can only be turned downward to ground (107) not shown) once support gussets 52Ga and 52Gb clear the end of gusset slots 52Sa and 52Sb. Conversely, with support posts assemblies 52Gc and 52Gd pushed inward for transport, support post assemblies 52Zc and 52Zd are prevented from turning and are kept secured for transport. Also, as shown, the danger and possible damaging effects of allowing support posts 52Zc and 52Gd to rotate downward and possibly scrape against vehicle 19 is eliminating because support gussets 52Ga and 52Gb must clear end of gusset slots 52Sa and 52Sb before rotating downward. The current roof strut 22 being used is a 2 ½″ aluminum square tubing with a 3/16″ wall thickness and the support post beam is made of 2″ Diameter aluminum round tubing with a wall thickness 3/16″. If a larger than acceptable gap should occur or should undue friction result between any of these components, an adhesive backed UHMW tape cam be applied in the desired thickness to the surfaces of one or more of these components to reduce the gap between them as well as to reduce friction and cause a smoother operation.

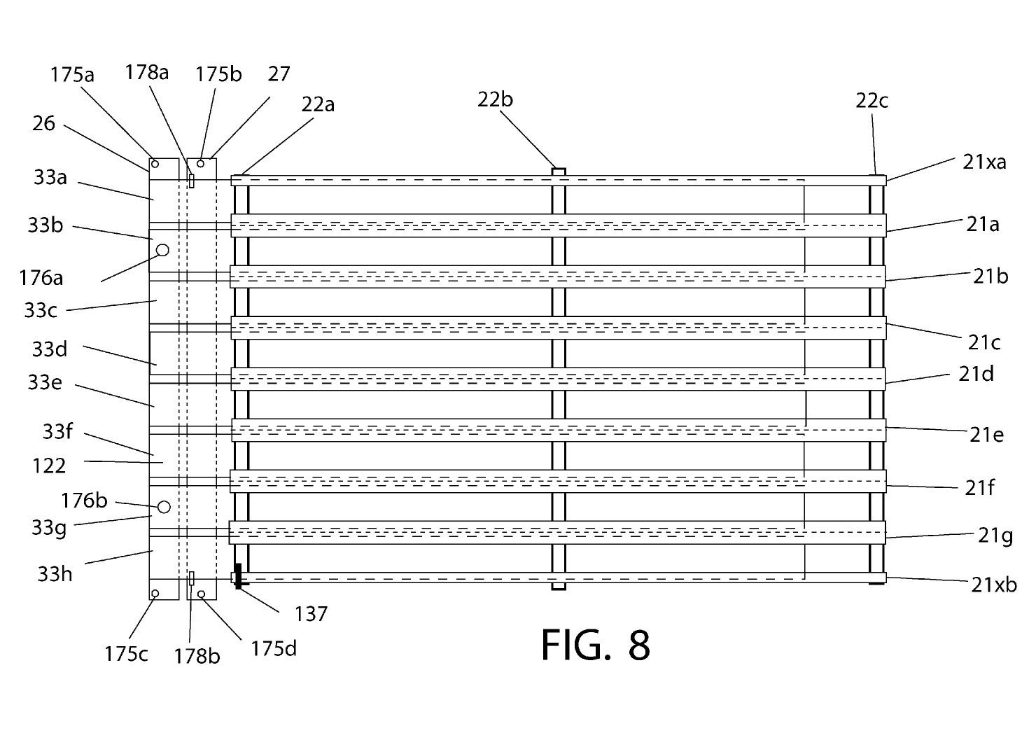

FIG. 8 is a top view of base frame 20 of collapsible platform 16C. As shown, floor beams 21a, 21b, 21c, 21d, 21e, 21f, 21g and side channels 21xa and 21xb are secured to and on top of roof struts 22a, 22b and 22c via welding, bolts, glue and or riveting. Inserted inside of the web openings of side channel 21xa and floor beams 21a, 21b, 21c, 21d, 21e, 21f and 21g and side channel 21xb are deck modules 33a, 33b, 33c, 33d, 33e, 33f, 33g and 33h respectively. Deck end support 26 is fastened to decks modules 33a, 33b, 33c, 33d, 33e, 33f, 33g and 33h via nuts and bolts and or welding so that these components when attached to one another act as a single unit—referred to as deck frame 25. While deck support 27 is attached and able to slide or move along deck modules 33a to 33h via rollers to provide a center area of support under deck frame 25 when deck frame 25 is extended out from base frame 20. Guard rail tube stubs 175b and 175d may be secured to deck support 27 and guard rail tube stubs 175c and 175a on deck end support 26. Also shown are deck support post insert housings 176a and 176b welded to deck end support 26 to provide a point of anchor and stabilization when using deck support posts 129a and 129b. Also shown are deck support locking pins 178a and 178b that are used to secure deck support 27 when it is placed in its stowage position and when it is placed near the center of deck frame 25 is extended for more floor area. To hold and secure deck frame 25 in place during transport, deck locking pin 137 is placed through a hole in side channel 21xb or drive assembly 66 (not shown). To extend deck assembly 122 from base frame 20 for use, locking pin 137 is removed.

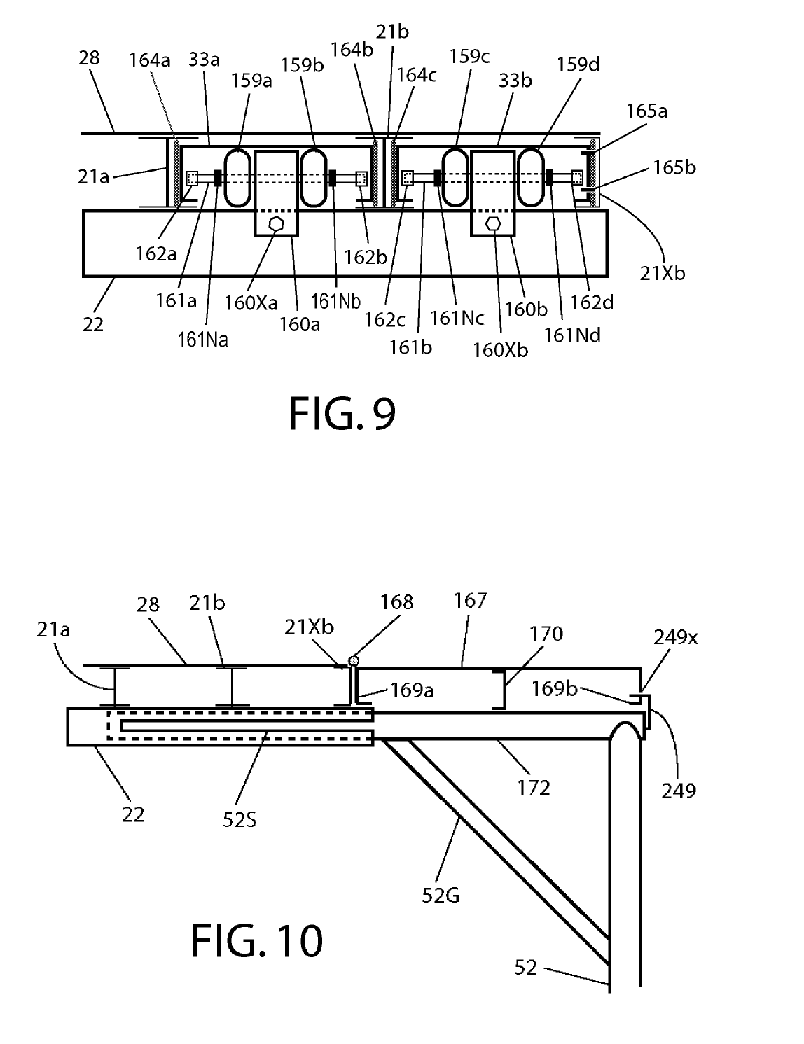

FIG. 9 is a front view of the right side of base frame 20 showing floor beams 21a, 21b and 21xb secured to and between roof strut 22 and floor 28. Aluminum diamond plate sheet is typically used for floor 28 and deck modules 33a and 33b, as shown, because they are both lightweight and provide a slip resistant surface. Because deck modules 33a and 33b need to slide in and out of base frame freely, especially because the exterior sides contain rough and extended diamond type shapes for grip, they should not rub against other components such as roof strut 22, floor beams 21a and 21b or the underside of floor 28. To provide a low friction and smooth operational design for sliding deck modules 33a and 33b as well as deck modules 33c, 33d, 33e, 33f and 33g (not shown), in and out of base frame 20, as shown deck modules 33a and 33b are raised, supported and maintained by attaching roller supports 160a and 160b to roof strut 22 via fasteners 160xa and 160xb respectively. It is important to note that the only smooth side of deck module 33 is the underside and as a result, it is the underside and inside surfaces that can be guided and supported best without any scraping or bumpy movement. Rollers 159a and 159b are supported on roller axle 162a that is in turn secured to roller support 160a to maintain deck module 33a raised above roof strut 22, the various surfaces of floor beams 21a and 21b and kept below from the underside of floor 28. While rollers 159a and 159b, roller support 160a and roller axle 161a maintain deck module 33a in the desired vertical position, end caps 162a and 162b secured roller axle 161b and end caps 162c and 162d on roller axle 161b, which are typically made of nylon, UHMW or other synthetic wear materials maintains deck module 33a in a centered position between floor beams 21a and 21b. Axle pins 161Na and 161Nb are fixed on roller axle 161a and axle pins 161Nc and 161Nd are fixed on roller axle 161b so they are all centered for proper alignment. Typically, from four to eight deck modules 33 will be used with each base frame 20. The design described above may be used with all eight deck modules 33aand 33b and 33c, 33d, 33e, 33f and 33g (not shown). To prevent scraping of the back end of deck module 33a as it moves through the space provided by roof beams 21a and 21b, rear guides 164a and 164b are secured to deck module 33a. Side channels 21xb and 21xa (not shown) are shaped in the form of a channel and used on sides of base frame 20.

FIG. 10 is a front view of the right side of collapsible shelter 16. As shown, extension floor 167 is extended outward from base frame 20 via extension floor hinge 168. For set up, support post 52 and support beam 172 (which are welded together) is pulled outward from inside roof strut 22. Typically, this component must be pulled outward from its stowed position to clear the side of the vehicle 19 (not shown) when placed in its vertical position. It should be noted that this component may weaken and provide less support the further that it is pulled out from roof strut 22, especially if vehicle 19 (not shown) is pulled away so that collapsible shelter 16 becomes free standing. To provide further support to extension floor 167, extension floor support 173 is pulled outward from its stowed position, inside of support post beam 172 so that support brace 170 and support flange 169b of extension floor 176 may rest on it. Also shown is extension floor support 173 with end cap 171, with locking tab 269 attached, that passes through locking slot 249x of extension floor 167. When locking tab 259 is engaged with locking slot 249x, extension floor 167 can raise up easily, especially under windy conditions. Floor 28 may be welded, bolted, glued and or riveted to roof beam(s) 21a. Extension floor hinge 168 may be welded, bolted, glued and or riveted to side channel 21x of base frame 20 and support flange 169a of extension floor 167. Velcro or other fastening means may be used to hold extension floor 176 secured to extension floor support 173 in place of locking tab 249.

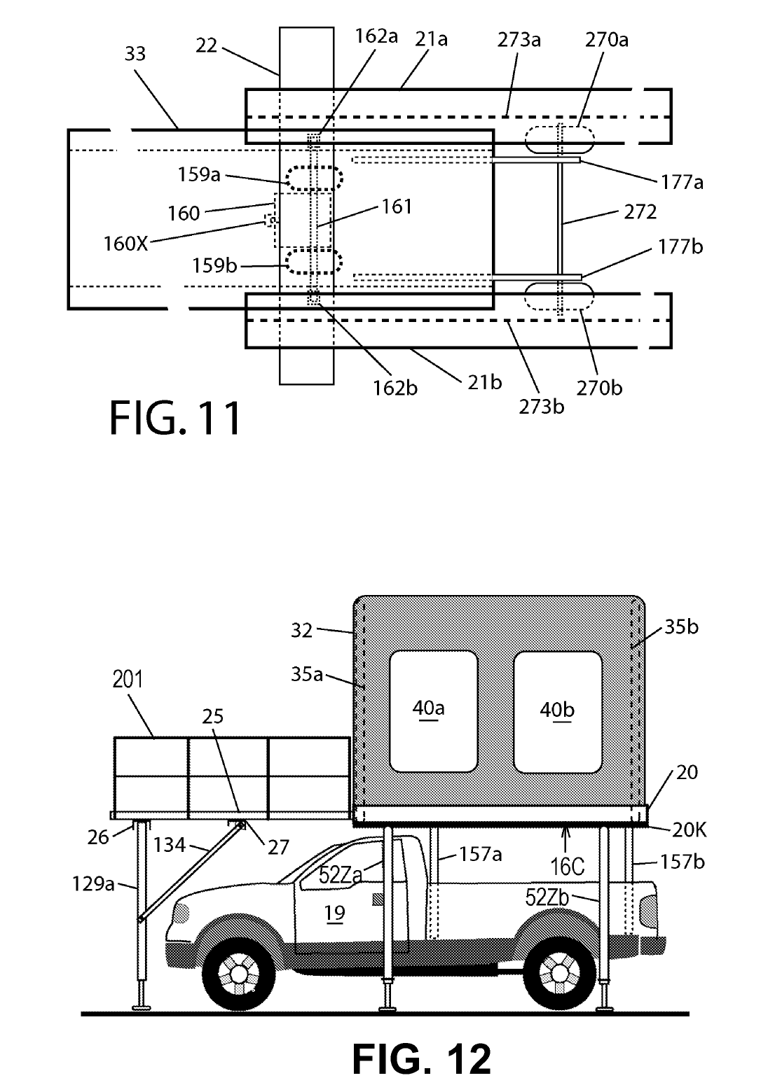

FIG. 11 is a top view of a single deck module 33 as contained between floor beams 21a and 21b. As shown, roller support 160 is secured to roof strut 22 via fastener 160X, weld or other permanent or temporary means. Rollers 159a and 159b are supported and held in place by roller axle 161 that is in turn supported by roller support 160. Rollers 159a and 159b support the smooth surface of the underside of deck module 33 to maintain deck module 33 in the proper elevation above and below the horizontal flanges of floor beams 21a and 21b so that no rubbing occurs. Also shown are end caps 162 and 162b that are secured to opposite ends of roller axle 161 to act as linear guides to maintain deck module centered so that its exterior surface, which is a raised and rough diamond shape, does not come in contact with the vertical component of floor beams 21a and 21b. Some space is provided between the ends of end caps 162a and 162b, which may be made of nylon, UHMW or other synthetic wear material and the interior sidewall flanges of deck module 33 so that pinching does not occur causing undue friction to result. Deck wheel flanges 177a and 177b are fixed to the back end of deck module 33 to provide support for guide axle 272 and deck wheels 270. To help center wheels 159a and 159b, the bottom flanges roof beams 21a and 21b can be sloped down toward their outward edges. Also, if any rubbing should take place against the vertical flanges 273a and 273b of floor beams 21a and 21b respectively, guide axle 272 will extend beyond deck wheels 270a and 270b and provide a much smaller surface area of rubbing than deck wheels 270a and 270b. Ends of guide axle 272 can also be capped with a nylon or other synthetic wear compound to further minimize friction. Rollers 159a and 159b, linear guide 162 (not shown) and deck wheels 270a and 270b help ensure that deck module 33 may slide in and out of the stowage space created within the area between roof beams 21a and 21b without any rubbing and at a very low rate of friction. While almost all deck modules 33a to 33g (typically, from four to 8 units are used) may require an appropriate number of rollers (159) and wheels (270) for proper operation of each deck module, it may be possible to avoid using a linear guide 162 (not shown) for each deck module 33 because when deck end support 26 (not shown), all deck modules are somewhat fixed to help control their linear movement.

FIG. 12 is a side view of vehicle 19, which is a pick-up truck, with supports posts 52Za and 52Zb, which may be adjustable in length, provide additional support to collapsible platform 16C. Also shown is flexible enclosure 32 opened up with u-frames 35a and 35b in the vertical position. Also shown is deck frame 25 extended outward, with railing 201 attached.

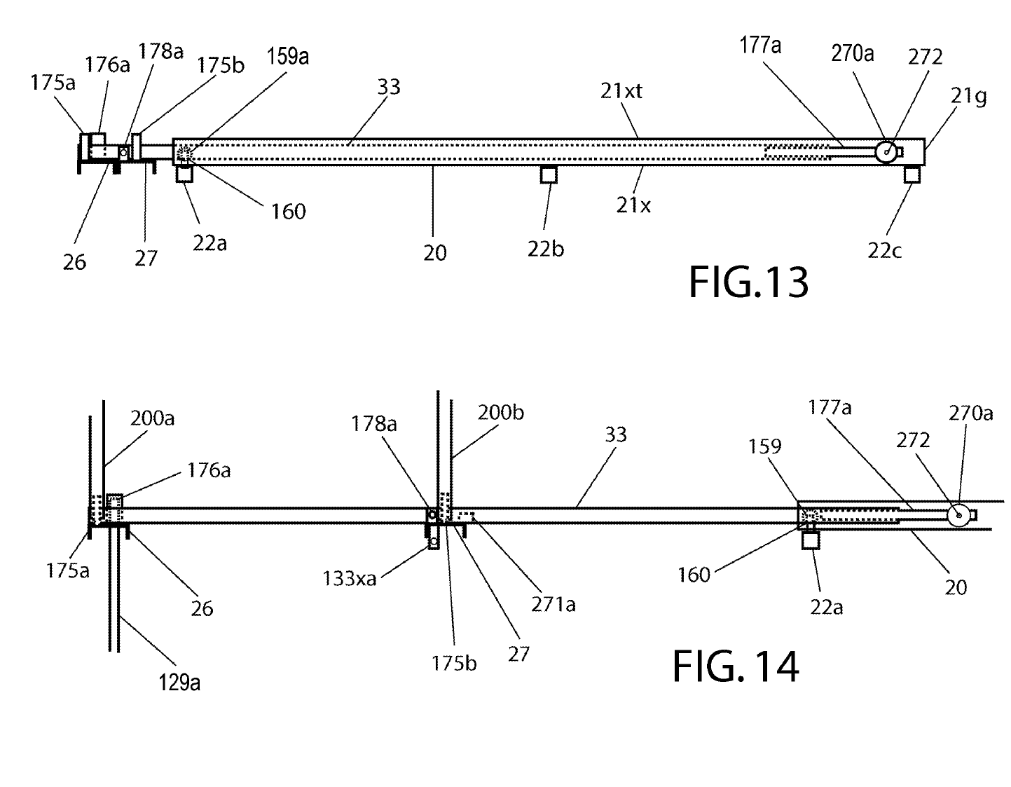

FIG. 13 is a side view of base frame 20 showing a single deck module 33 placed within the web dimensions of floor beam 21g (I-Beam shape) and side channel 21xt. To provide further support and smooth operation to deck module 33 when being moved in and out of base frame 20, back end of deck module 33 is equipped with deck wheel flange 177a and 177b (not shown) with wheel 270a and 270B (not shown). Together, rollers 159a and 159b (not shown), linear guide 164 (not shown) and deck wheels 270a and 270b (not shown) enable deck module 33 to ride in and out easily within base frame 20. As shown, deck end support 26 is fixed to front end of module(s) 33 and deck support 27 is equipped with deck support slide rails 271a and 271b (not shown) to allow deck support 27 to slide along deck module 33 on wear strips or rollers for set up. Deck end support 26 is equipped with guard rail tube stubs 175a and 175b (not shown) as well as deck support post insert housings 176a and 176b (not shown). Deck support 27 is equipped is equipped with deck support locking pin 178a, guard rail tube stubs 175b and 175a (not shown) and deck support slide rails 271a and 271b (not shown). Also shown as part of base frame 20 are roof struts 22a, 22b, 22c, 22d and 22e fixed to floor beam 21g.

FIG. 14 is a side view base frame 20 showing deck module 33 fully extended. As shown, deck wheel flanges 177a and 177b also help to limit the distance that deck module 33 may be pulled out from base frame 20 because it will come up against roller support 160 and rollers 159a and 159b (not shown). When deck end support 26 and deck support 27 are installed on deck module 33, the weight towards the outward end of deck module 33 increases the load on deck wheel 270a and 270b (not shown) and deck flanges 177a and 177b (not shown) the farther out the deck module 33 and or deck assembly 122 (not shown) is pulled out of base frame 20. As a result, additional deck wheels (270) may be required. Typically, the distance between roller support 159 fixed on roof strut 22a to deck wheel 270a is approximately 18″. Deck module 33 may be bolted to deck end support 26 using a bolt and nylock nuts and may not necessarily be tightened to allow some movement between deck modules and deck end support 26 so that deck assembly 122 (not shown) doesn't become jammed within base frame 20. As shown, deck end support is equipped with guard tube stub 175a and deck support post insert housing 176a. Deck support post 129 is shown inserted into deck support post insert housing 176a. Deck support post insert housing 176a and 176b (not shown) may be fixed to deck end support 27 via a hinge or by some other type of attachment such as a cable or tether or may be carried loosely and installed at the time set up. Also shown is deck support 27 locked in place under deck module 33 with deck support locking pin 178a in place. Guard rail tube stub 175b is shown welded to deck support 27 to provide an anchor for guard rail post 200b. Guard rail post 200a is shown installed on guard rail tube stub 175a. Deck brace flange 133xa is shown attached to deck support 27.

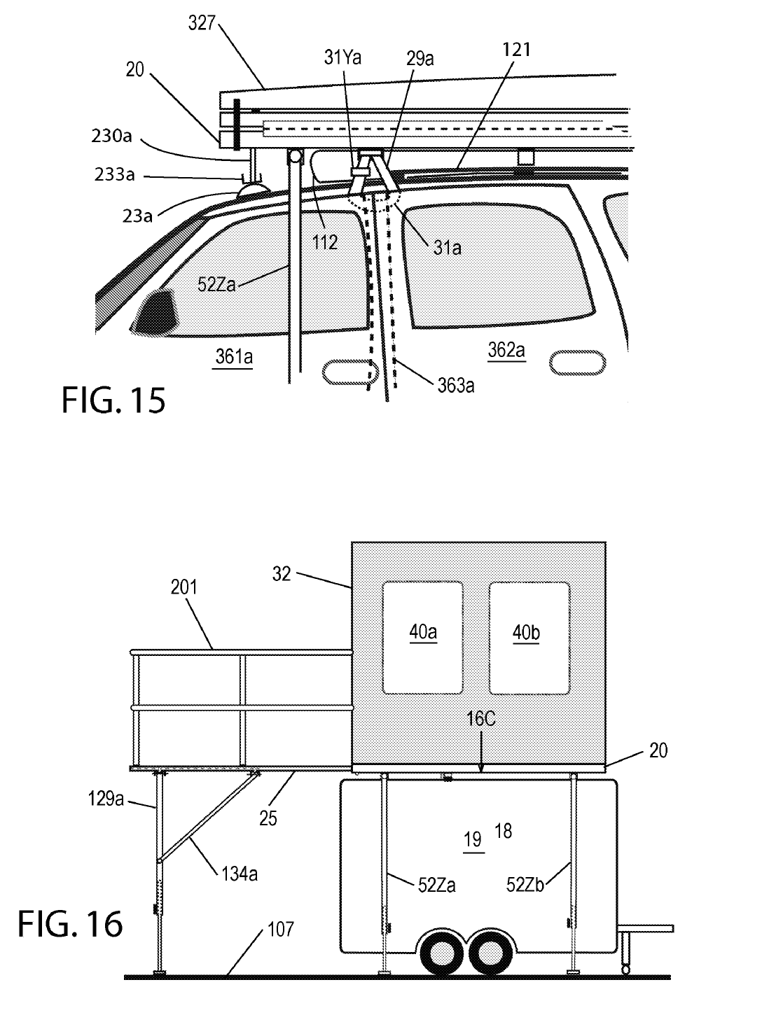

FIG. 15 is a partial side view of vehicle 19 showing a detailed method for mounting collapsible platform 16C on vehicle roof 18. In addition to avoiding the costly and massive task of providing specialized attachment components for each type of vehicle, and especially for each type of roof rack, it is also important to prevent any small areas of vehicle roof 18 from supporting heavy, concentrated loads. Once base frame 20 is properly leveled and positioned on vehicle roof 18, which may or may not rest on roof rack 121, by adjusting extensions bolts 230a, 230b (not shown), 230c (not shown) and 230d (not shown), safety strap 31a may be extended from safety flange 29a on base frame 20 in and around door post 363a and then fastened and tightened to webbing clamp 31Ya. Once safety strap 31a is secured, doors 361a and 362a may be closed. In addition to spreading the weight of collapsible platform 16C across a large area of vehicle roof 18, instead of applying most of the weight to vehicle roof via suction cups 23a, 23b (not shown), 23c (not shown) and 23d (not shown) rest, which could cause damage to vehicle 19, support membrane 112 may be inflated with low pressure air (0.25 to 2 PSI) to press against vehicle roof 18 and underside of base frame 20 to create a compression type of fit of collapsible platform 16C to vehicle 19. Also, filling support membrane 112 with a foam material, similar to the type used for packaging or insulation will basically provide the same result and in some cases provide a better fit because it can be molded for an exact fit a particular vehicle. For most installations, it may not be desirable to attach collapsible platform 16C to roof rack 112 as provided by manufacturer of vehicle 19.

FIG. 16 is a side view of collapsible platform 16C installed on vehicle 19 which in this case is a trailer. As shown, deck frame 25 is extended from base frame 20 to almost double the floor area of base frame 20. Because most trailers, RV's, ATV's, boats and other specialized vehicles are not built with enough floor loading capacity to support one or more people safely and are basically just engineered to keep the elements out, collapsible platform 16C can provide an extra living space option that is light, strong and easily installed and removed. With support posts 52Za, 52Zb, 52c (not shown) and 52Zc and 52Zd (not shown) and deck support posts 129a and 129b (not shown) extended to ground 107, collapsible platform 16C and deck frame 25 may safely support up to five to people. As with all of the various models and configurations of collapsible platform 16C, vehicle 19 may simply be used as a transport method so that when one reaches their destination such as a horse show event that may last for a few days, that vehicle 19 which is a trailer in this case can be pulled away from collapsible platform 16C so that it can be used as a two story shelter with a flexible enclosure 32b (not shown) used underneath base frame 20 as well as on top of base frame as shown with enclosure 32 with windows 40a and 40b. Guard rail assembly 201 may be made with flexible cable, webbing or with rigid length of metal tubing.

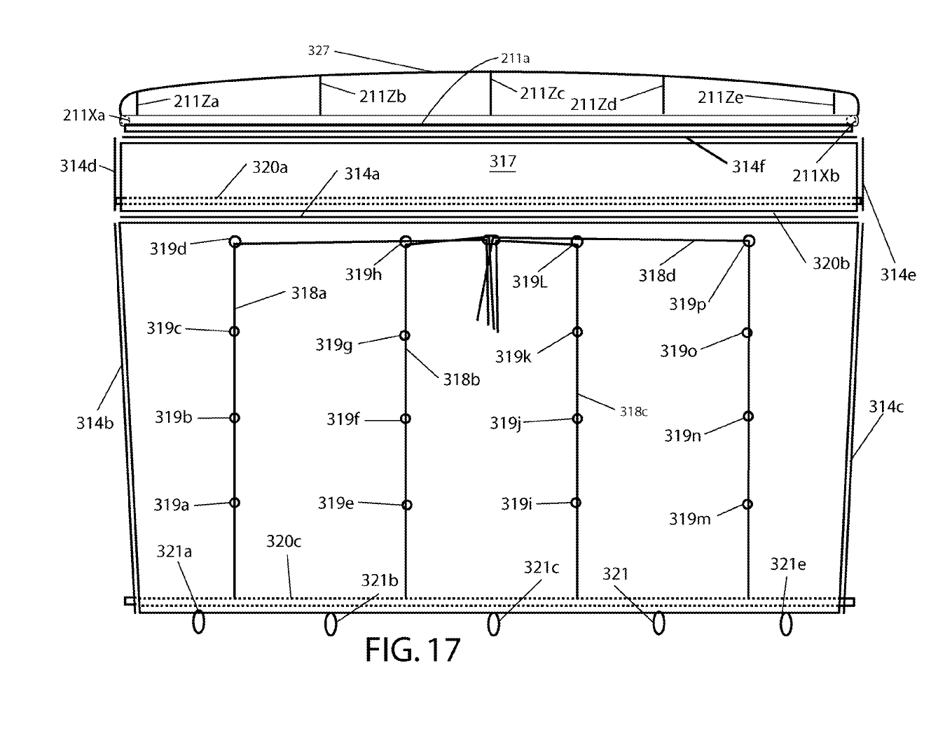

FIG. 17 is a side view of roof assembly 327 of used with portable platform 16p. The roof post assemblies 297Za, 297Zb, 297Zc and 297Zd are not shown in this drawing. Roof beam 211 of roof assembly 327 may be equipped with zipper 314f, that may continue as one piece or as separate sections to form a perimeter means of attachment for enclosure sidewalls 37a (37b, 37c and 37d not shown) on roof assembly 327. As shown, roof extension 317 is also equipped with zipper edge to connect it to roof assembly 327 by closing zipper 314f. Roof extension 317 may also use the same fabric and cover that is used on roof assembly 327. Sides and bottom of roof extension may also be equipped with zippers so that enclosure sidewall 37a may be added as to help form part of a totally enclosed area. Enclosure sidewall 37a is also equipped with a “Venetian Blind” style of folding mechanism as shown by curtain rings 319a to 319m being attached to enclosure sidewall panel 37a.

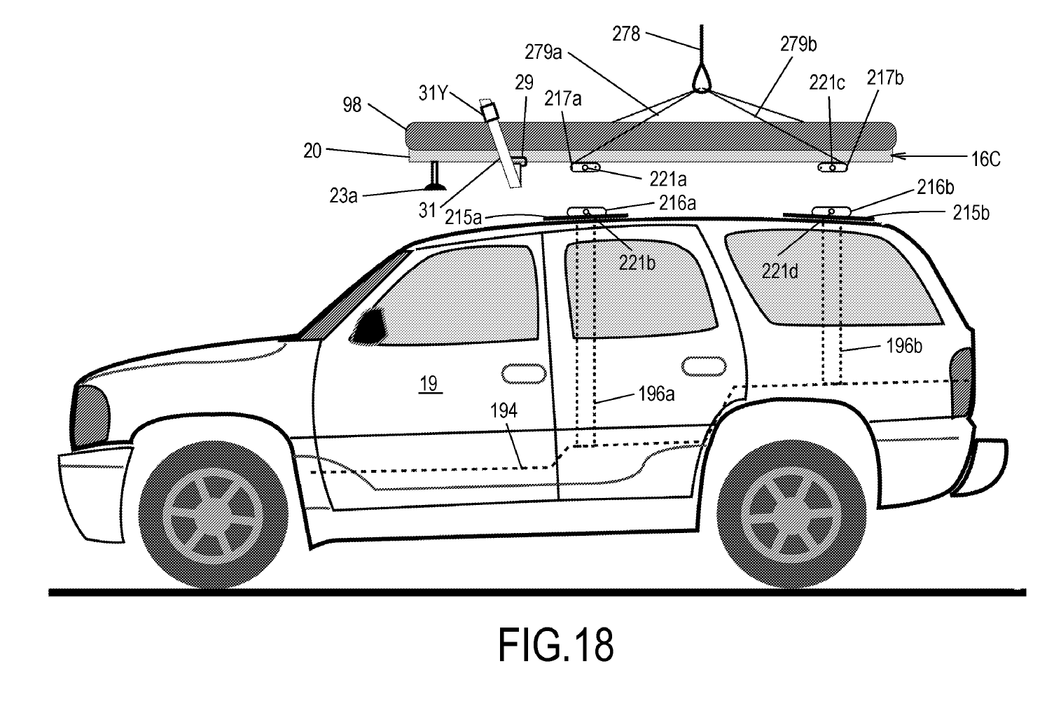

FIG. 18 is a side view of vehicle 19 with collapsible platform 16C 16 positioned overhead and hanging from lift cable 278 via lift straps 279a, 279b, 279c and 279d to base frame 20 above vehicle roof 18. Lift cable 278 and lift straps 279a, 279b, 279c and 279d may be operated from a fork truck, walkie-stacker, hoist, crane, block and tackle, pulley, winch or other lifting device. Vehicle 19 is equipped with interior supports 196a and 196b, which may be specially designed and engineered for each type of vehicle, that includes connecting roof plates 215a and 215b and 215c and 215d (not shown) to add further stability and support to provide a more engineered method of utilizing collapsible shelter 16. Roof plates 215a and 215b and 215c and 215d (not shown) are equipped with roof plate brackets 216a and 216b and 216c and 216d (not shown) respectively that may interface quickly and easily with frame brackets 217a and 217b and 217c and 217d (not shown) on base frame 20. Obviously, this type of attachment method would eliminate added adjustment and specialized attachment procedures as with the use of suction cups, strapping and dealing with a variety of different roof designs. Once collapsible platform 16C is lowered onto vehicle roof 18 and roof plate brackets 216a, 216b, 216c and 216d are aligned with frame brackets 217a, 217b, 217c and 271d are aligned respectively, locking 218a, 218b, 218c and 218d may be installed as required. Once locking pins 217a, 217b, 217c and 217d are installed to lock collapsible shelter 16 on vehicle 19, lifts straps 279a, 279b, 279c and 279d may be unfastened from base frame 20. The design and engineering of an interior support frame (196) can be made to support collapsible shelter 16 and the load of occupants, camping gear, supplies, etc . . . without the use of supports post assemblies 274a, 274b, 274c and 274d (not shown) Also shown is safety strap 31, secured to safety flange 29a with safety strap ratchet (used for tightening) that may be passed through windows or doors to connect with safety flange 29b (not shown) on the adjacent side of base frame 20. Suction cup 23a may be used to add further stability to collapsible shelter while in use. Collapsible platform 16 may also be permanently installed on vehicle is desired. Notice that in this configuration that support post assemblies 297Za, 297Zb, 297Zc and 297Zd (not shown) are not required. Also absent is support membrane 112 (not shown).

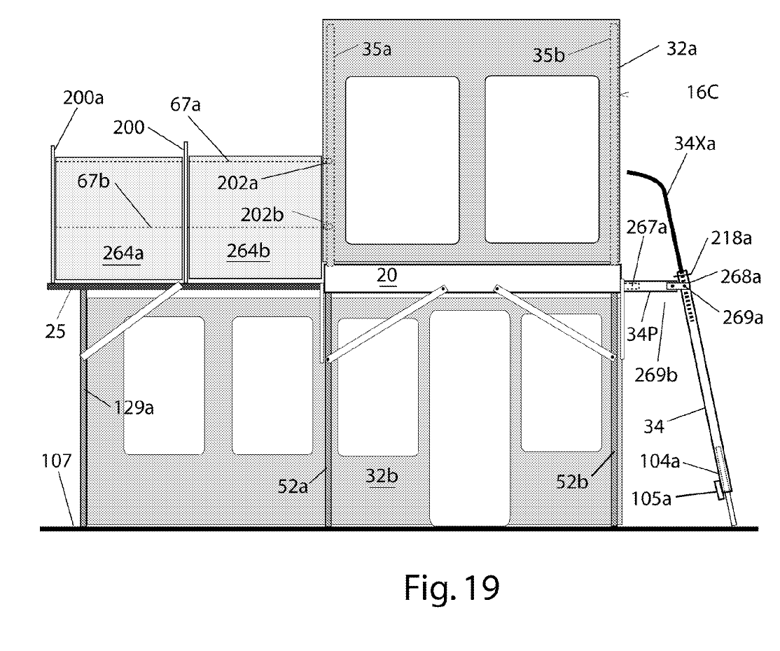

FIG. 19 is a side view of collapsible platform 16C with base frame 20 supported on support posts 52a and 52b and deck frame 25 supported on deck support post 129a. Ladder 34 is supported and attached to base frame 20 via ladder stubs 267a and 267b (not shown) to ladder platform 34P. Ladder platform 34P is in turn connected to ladder 34 via ladder flange 268a and 268b (not shown) secured to ladder axles 269a and 269b so that ladder platform 266 may be folded against ladder 34 for storage. Ladder 34 may also be equipped with extension legs 104a and 104b (not shown) and may be adjusted via leg locks 105a and 105b (not shown) for varying heights. Also, to provide greater safety for persons using ladder 34 with collapsible platform 16C, ladder hand rail 34Xa and 34Xb (not shown) may be extended upward to provide stability for persons entering and existing floor 28 of base frame 20. Ladder extensions rails 34Xa and 34Xb (not shown) may be raised and lowered inside or outside of tubing, which may be 2″ Schedule 40 aluminum pipe and held in either an up or down position via locking pins 281a and 218b (not shown) or on the outside of ladder 34. In addition to ladder 34 being removable from base frame 20, ladder 34 may also be permanently attached to collapsible platform 16. Also show in flexible shelter 34b attached to the underside of deck frame 25 and base frame 20. Guard rail posts 200a and 200b are shown as attached to deck frame 25 with railing 67a and 67b, which is typically aircraft cable, secured and connected to u-frame 35a via rail connectors 202a and 202b respectively. Based on a collapsed area inside of base frame 20 of collapsible platform 16C which is approximately 40 cubic feet, the sheltered space available for use when unfolded within flexible enclosure 32a is approximately 260 cubic feet. An additional 600 cubic feet of sheltered living space is available when flexible enclosure 32b is set up. In addition to the sheltered living space created by flexible enclosures 32a and 32b, another 40 sq. ft. of floor area is available on deck frame 25 when it is extended from base frame 20. Certainly, a rather large sheltered area can be created from the simple base frame 20 and other lightweight and movable components for temporary living space with the invention.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

I claim:

1. A vehicle roof collapsible platform convertible to living space apparatus (16C) comprising:
a rigid base frame (20) having a base frame front, a base frame back, and two base frame sides alignable to the front, back, and sides of a vehicle; and
a plurality of support post assemblies (52Z) that can be stowed on the base frame (20) during transport and extended to ground when vehicle is parked or removed to transfer the weight of cargo and people onto a collapsible platform (16C) or to ground (107) so as not to cause damage to vehicle, and thereby enabling the apparatus to be used while the apparatus is on top of a vehicle or after the vehicle has been removed from under the deployed apparatus.

2. The apparatus of claim 1 further comprising a support membrane (112) secured to the base frame adapted for distributing and supporting the weight of the apparatus over a vehicle roof, the support membrane having a side that is flat against the base frame and takes the shape of a vehicle roof when the membrane is inflated.

3. The apparatus of claim 2, wherein the support membrane (112) is filled either with air or with expanded foam.

4. The apparatus of claim 1 further comprising:
a plurality of extendible roof posts (36) secured to the frame base (20) adapted for supporting the apparatus and occupants without any support from a vehicle roof; and
a roof assembly (327) secured to the extendible roof posts (36) that defines a living space sufficiently tall for an adult to stand up between the base frame and roof assembly when the extendible roof posts are extended.

5. The apparatus of claim 1 further comprising a ladder (34) removably secured to the base frame (20).

6. The apparatus of claim 5 further comprising a ladder hand rail (34X) connected to the ladder (34) at a ladder top so that the ladder hand rail can be positioned to assist a user when a user's feet are near the top of the ladder.

7. The apparatus of claim 5 further comprising a ladder platform (34P) secured to the ladder (34) at one end and the base frame (20) at another end.

8. The apparatus of claim 1 further comprising a plurality of suction cups (23) secured to the base frame for securing, leveling and height adjustment above the roof of the apparatus on a vehicle roof to help prevent it from sliding when installed.

9. The apparatus of claim 1 further comprising a deck (25) secured in a parallel rolling relationship with the base frame (20) such that substantially all of the deck can be disposed within the area of the base frame (20) and extended outward from the base frame front when in use.

10. The apparatus of claim 9 further comprising a plurality of deck support posts (129) secured to the deck (25).

11. The apparatus of claim 10, further comprising a plurality of frame beams (139) secured to the deck support posts (129) as cross bracing to make the deck (25) rigid when in use.

12. The apparatus of claim 1 further comprising a vehicle (19), wherein the vehicle is one selected from the group consisting of an automobile, truck, trailer, ATV, RV, and boat.

13. The apparatus of claim 1 further comprising at least one safety strap (31) secured to a base frame side adapted to engage a vehicle door post, thereby preventing the apparatus from sliding off a vehicle roof and making the apparatus secure for use on any four door vehicle having a door post without resorting to vehicle-specific securing apparatus.

14. The apparatus of claim 1 further comprising at least one safety strap (31) secured to a base frame first side adapted to run through a vehicle interior through vehicle doors or windows and be secured at a base frame second side, thereby preventing the apparatus from sliding off a vehicle roof and making the apparatus secure for use on any four door vehicle having a door post without resorting to vehicle-specific securing apparatus.

15. The apparatus of claim 1 further comprising a plurality of frame beams (139) secured to the support posts (52) as cross bracing to make the apparatus rigid when in use.

16. The apparatus of claim 1 further comprising guard rails (201).

17. The apparatus of claim 16, wherein the guard rails (201) have a rigid railing.

18. The apparatus of claim 16, wherein the guard rails (201) have a flexible railing.

19. The apparatus of claim 6, further comprising:
a roof assembly (327);
a roof post assembly (297Z) and;
post locks (355), whereby the roof post assembly is attached to the ladder hand rail assembly using post locks to maintain the roof post assemblies in a vertical position and the roof assembly locked in position for use.

20. The apparatus of claim 6, further comprising:
guy wires (364); secured from
roof post assemblies (297Z) to a floor for added stability of
a roof assembly (327) and roof post assemblies, so that the ladder hand rail hold prevents the apparatus from moving back and forth while the guy wires present the apparatus from moving from side to side.

21. The apparatus of claim 4 further comprising a top flexible enclosure (40) enclosing the space between the base frame and roof assembly.

22. The apparatus of claim 4 further comprising a bottom flexible enclosure (32) enclosing a living space between the base frame and the ground.

23. The apparatus of claim 1 further comprising:
one leg extension (104) corresponding to each support post (52); and
one leg lock (105) corresponding to each leg extension (104), whereby the length of the support posts can be adjusted.

24. The apparatus of claim 8 further comprising:
extension bolts (230); and
suction cup flanges (233) to provide a means for adjusting the height of the apparatus above a vehicle roof and for leveling the base frame on the roof, and thereby making the apparatus adaptable to an unlimited number of vehicle types.

25. The apparatus of claim 1, further comprising two folding side floor extensions (167) connected to the base frame (20) that increase the floor area of the apparatus when extended.
